(19) United States
(12) Patent Application Publication
(10) Pub. No.: US 2003/0174731 A1
(43) Pub. Date: Sep. 18, 2003

(54) Protocol stacks

(76) Inventors: Rahim Tafazolli, Surrey (GB); Klaus Moessner, Hohberg-Diersburg (DE); Seiamak Vahid, Wiltshire (GB)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/275,776

(22) PCT Filed: May 16, 2001
(86) PCT No.: PCT/GB01/02169

(30) Foreign Application Priority Data
May 17, 2000 (GB) 0011954.5

(51) Int. Cl. H04J 3/16

(52) U.S. Cl. 370/469; 370/395.5

(57) ABSTRACT

A protocol stack for a communications system has an architecture incorporating active programming interfaces capable of supporting reconfiguration of the stack. The stack has a plurality of layers (pro-layers) and a plurality of object-oriented interfaces (pro-interfaces) whose respective functionalities are defined by layer classes and programming interface classes. Execution of these functionalities is controlled by thread objects.

This invention relates to protocol stacks and to communications systems such as telecommunications systems incorporating protocol stacks.

The invention finds particular, though not exclusive application in so-called software-reconfigurable radios (SWRs) or soft-radios.

Protocol stacks are currently implemented in a way that multiple layers are placed on top of each other i.e. a stratification approach, each layer offering its internal functionality to other layers and the application via standardized interfaces known as Service Access Points (SAPs).

More specifically, protocol stacks are aggregations of several single protocols (layers), each of which has certain functionality and serves a certain task. Traditionally, protocol frameworks use the stratification approach as a composition mechanism. Protocols in one layer of the stack are impervious to the properties of the layers below. Each layer is treated as a ‘black box’ and there exists no mechanism to identify/bypass any functional redundancies, which may occur in the stack. A well-documented example of protocol stacks is the OSIRM (Open Systems Interconnection Reference Model), which consists of seven layers ranging from application, presentation, session, transport, network and data link layers to the physical layer. Each of these layers represents a complete protocol that offers its services to the next upper layer or expects services from the layer immediately below. This structure is described in “Computer Networks” by A. S. Tanenbaum, 3rd Ed, Prentice-Hall, 1996. The same principle applies to both mobile and fixed line telecommunication networks, and hence interworking functionality is defined in separate protocols. Communication between layers is accomplished via SAPs. Through these SAPs sets of primitives in a given layer become available to the next layer up the hierarchy. Services define operations to be performed within the layer and can be requested by upper layers. In effect, SAPs are used to encapsulate the layers, to hide their complexity and to uniquely describe the functionality that a layer provides and what upper layer users may request from them. However, SAPs are static and lack any flexibility. They do not support flexible changes in the protocol stack and need to be re-standardised in case any change becomes necessary.

These shortcomings of conventional protocol stacks present, inter alia, a significant obstacle to the implementation of SWRs which are evolving towards all-purpose radios which can implement a variety of different standards or protocols through reprogramming (see, for example, “The Software Radio Architecture” by J Mitola III, IEEE Comm. Mag. May 1995 pp 26-38 and “The Layered Radio” by M Butler et al, MILCOM, NY, 1998 pp 179-179). SWRs are emerging as viable alternatives to multimode terminals without the “Velcro approach” of including each possible/existing standard. Therefore, next generation mobile terminals and network nodes will require significantly richer capabilities in the control plane due to the need to support large numbers of diverse applications with different Quality of Service (QoS) requirements and traffic characteristics.

SWR terminals will also need to be reprogrammable and this reconfiguration requirement will not be confined to the physical layer alone. In summary, future SWR terminals and devices as well as network entities will only be able to efficiently respond to the needs of applications and user preferences if the capability to software download, reconfiguration and management are provided within terminals and supported by the network infrastructure. However, this cannot be achieved with the existing rigid protocol stratification approach.

One objective of the present invention is to alleviate at least some of the aforementioned problems by providing a protocol stack having active programming interfaces (Protocol Programming Interfaces (PPIs)/Application Programming Interfaces (APIs)) replacing the rather static SAPs used in conventional protocol stacks.

As described in “Towards an Active Network Architecture” by D Tennenhouse et al, Comp. Commun. Rev Vol 26, No. 2, April 1996, in “Active Networking Sources for Wired/Wireless Networks” by A Kulkarni et al, Proc. INFOCOM 99, Vol 3, NY 1999, pp 1116-23 and in “Composing Protocol Frameworks for Active Wireless Networks” by A Kulkarni et al IEEE Commun Mag March 2000 deployment of active nodes and interfaces would certainly facilitate introduction of differentiated or integrated services to support new multimedia applications as well as provide for smoother interworking functionality between media protocols (internet and IN) or different signalling systems (SS7, H323 etc). Also network management would become more intelligent and network capabilities would evolve rapidly through software changes without the need to upgrade the network infrastructure. Thus, it is envisaged that future reconfigurable mobile networks would benefit greatly from the deployment of active nodes and service interfaces.

Re-configuration through introduction of programming interfaces between protocol strata opens up the possibility to write both single protocols or even whole protocol stacks in a manner similar to the way applications are written in high level programming languages (e.g. Java applications use different APIs which are part of the class libraries with binding at runtime—this means that the functionality is out-sourced to the API and the application simply defines the sequence and determines the parameters passed to methods within the APIs). Other important design issues in software radio design concern proper reconfiguration of the radio i.e. reconfiguration management, which is responsible for runtime reconfiguration management, over-the-air down load protocol (described in “Terminal Reconfigurability—The Software Download Aspect” K Moessner et al IEE Int Conf On 3G 2000, March 2000, London UK) and security related aspects.

Alternative well-documented approaches to this general problem include the “Mobile Application Support Environment” (MASE) developed as part of the ACTS project “On The Move”, the Global Mobile API Framework, the Mobile Station Application Execution Environment (MExE) GSM 02.57 V70.0 ETSI, 1998 and IEEE P1520, the proposed IEEE Standard for Application Programming Interfaces for Networks.

According to the invention there is provided a protocol stack for a communications system wherein the stack has an architecture incorporating active programming interfaces capable of supporting reconfiguration of the stack.

Active programming interfaces are objects and need to comply to the object-oriented design principles.

The invention introduces a novel concept that redefines the interfaces between protocol layers, classifies interactions between different layers within the protocol stack and provides an architecture supporting protocol reconfiguration. This can be achieved by implementing active programming interfaces as objects within the protocol stack and by using object oriented design methods to define this new protocol stack architecture. Standardised active programming interfaces will introduce the additional degree of freedom necessary for standard reconfiguration of protocol stacks in both terminal and network.

Embodiments of the invention are now described, by way of example only, with reference to the accompanying drawings of which:

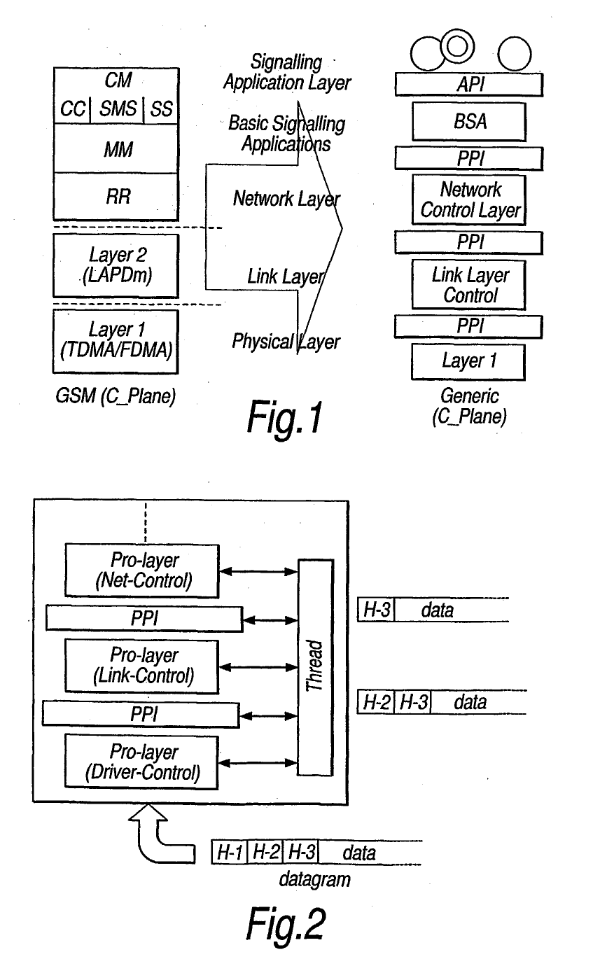

FIG. 1 illustrates the comparison between the control (C) planes of the legacy GSM and the ‘active programming interface’ protocol stacks,

FIG. 2 illustrates thread controlled message handling,

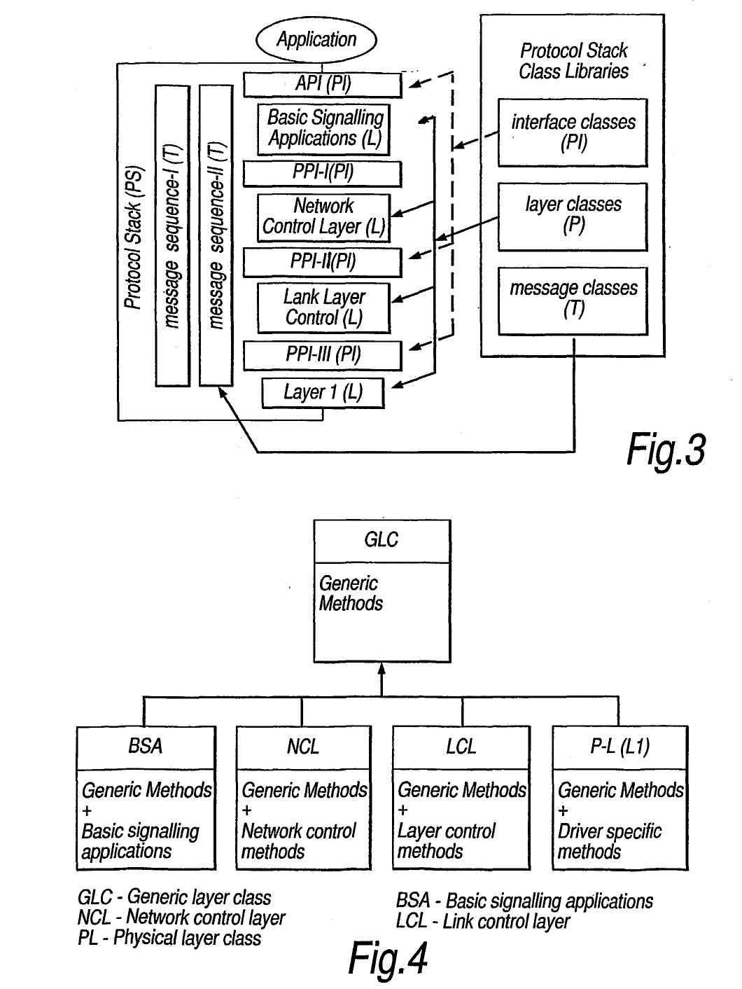

FIG. 3 illustrates a protocol stack structure and protocol stack class libraries,

FIG. 4 illustrates pro-layer classes,

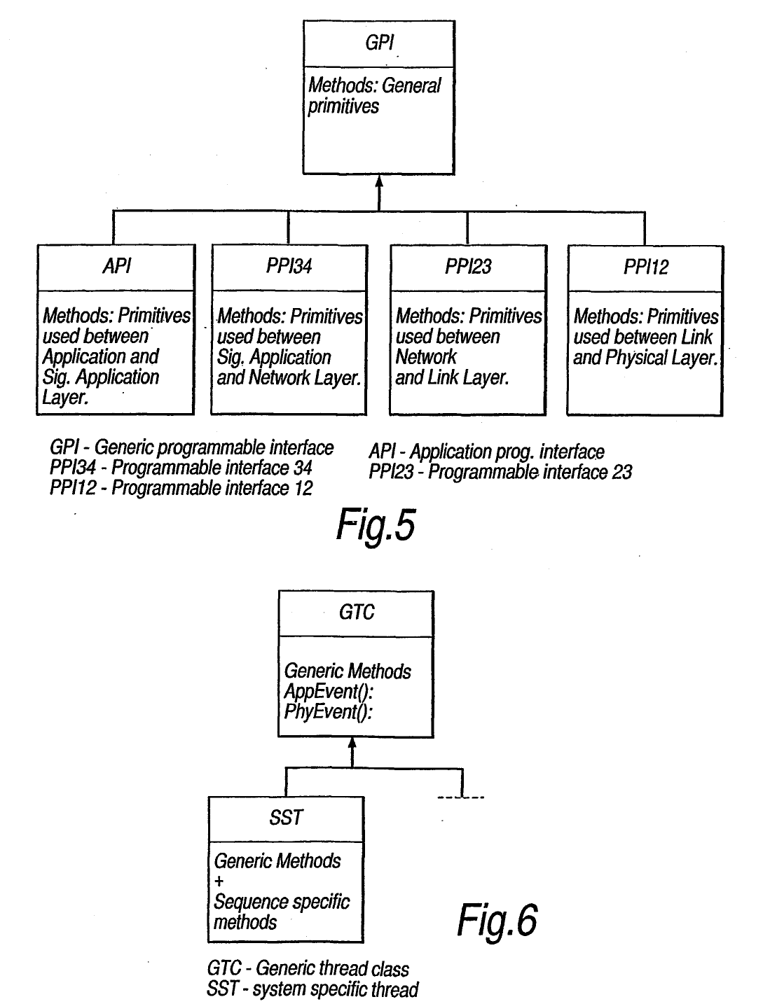

FIG. 5 illustrates interface class hierarchy,

FIG. 6 illustrates the thread class hierarchy,

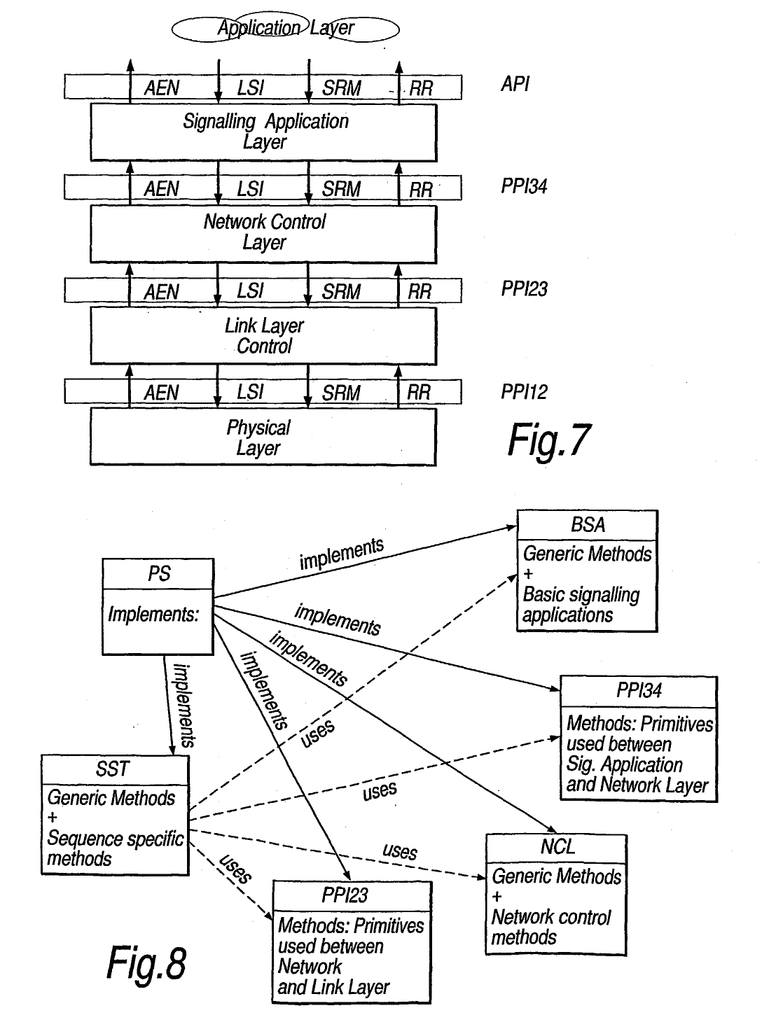

FIG. 7 illustrates interface primitives,

FIG. 8 illustrates PS class relations,

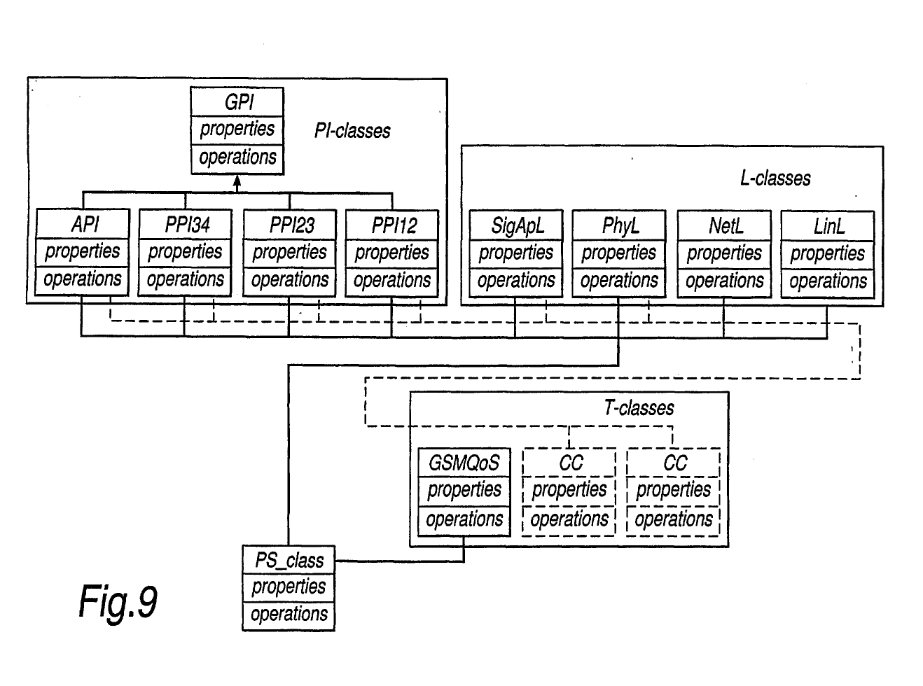

FIG. 9 illustrates hierarchy and class relations,

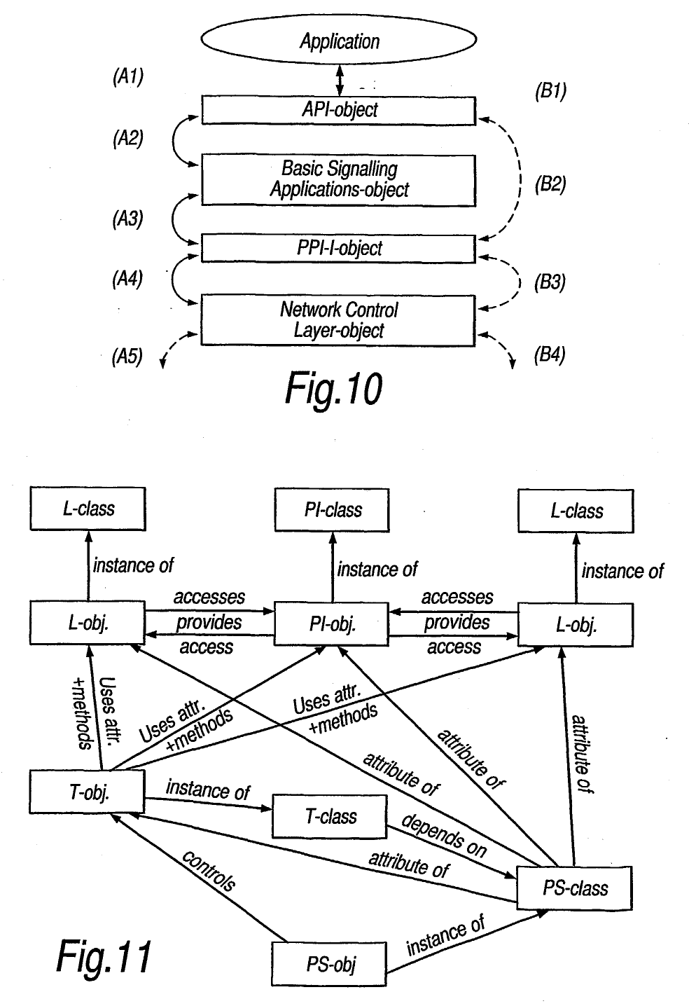

FIG. 10 illustrates active interface objects,

FIG. 11 illustrates class relations within the protocol stack,

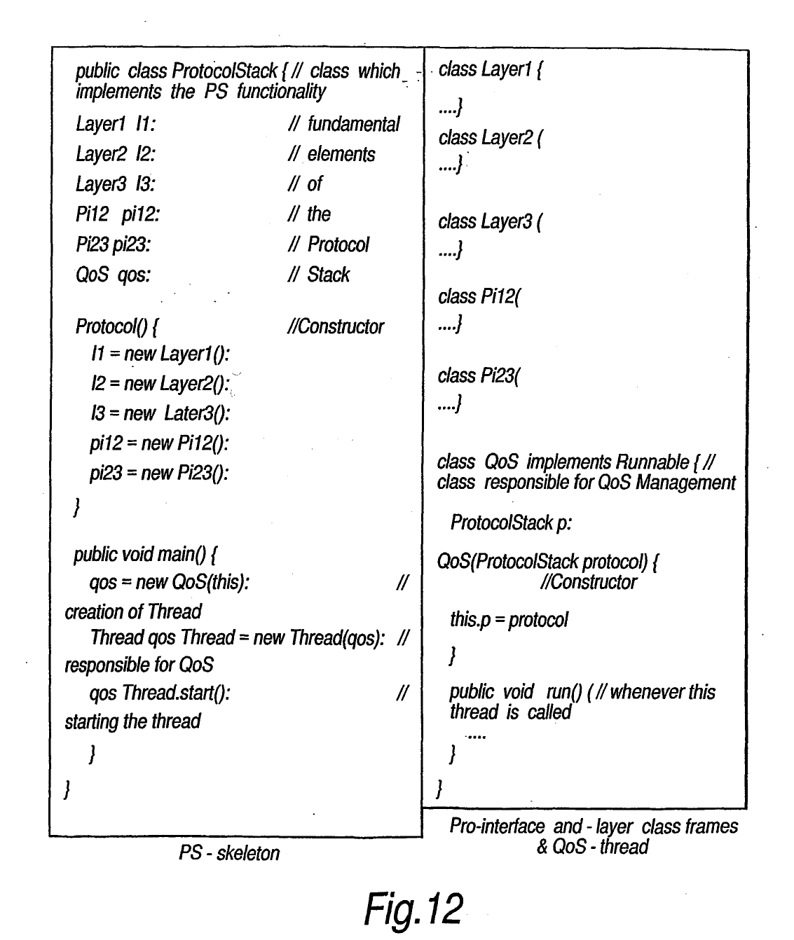

FIG. 12(a) illustrates sample skeleton code,

FIG. 12(b) illustrates class frameworks for pro-layers and pro-interfaces and provides an example of a thread class,

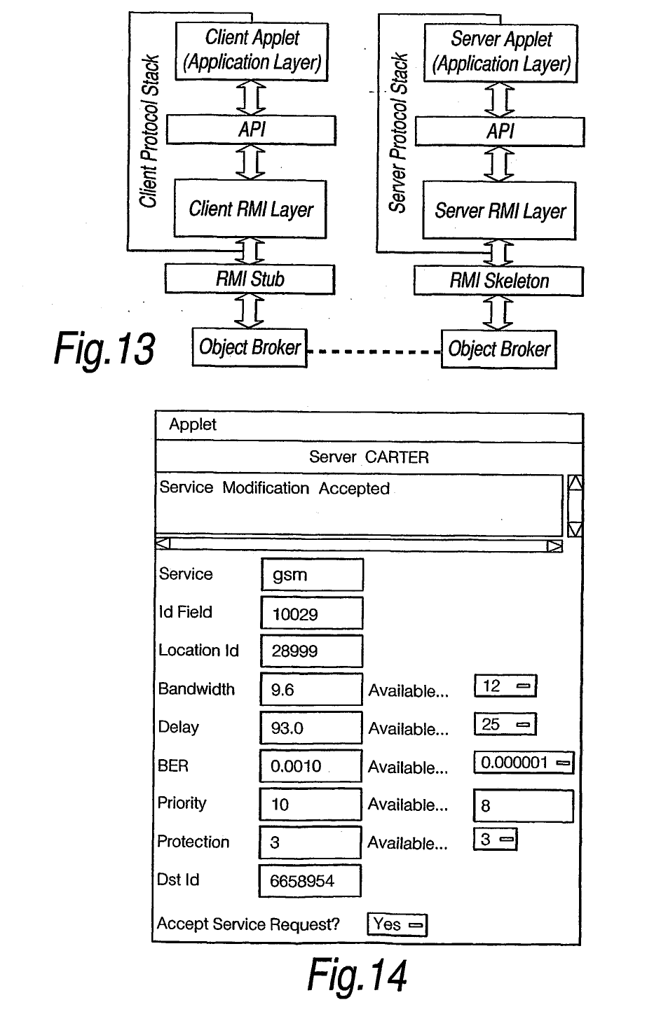

FIG. 13 illustrates a model implementation protocol stack,

FIG. 14 illustrates a server applet used in the model of FIG. 13,

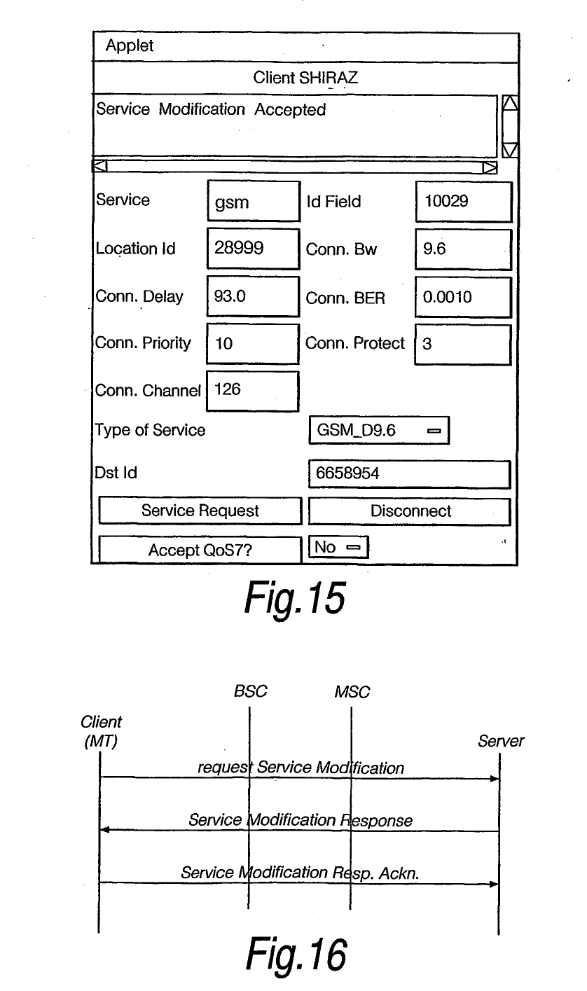

FIG. 15 illustrates a client applet used in the model of FIG. 13 and

FIG. 16 illustrates QoS modification message sequence.

The embodiments to be described conform to an open protocol programming interface model and architecture referred to hereinafter as OPtIMA.

II. The OPtIMA Approach

Software reconfiguration has been identified as a crucial technology to facilitate the realisation of software-defined radios. The main functionality of interest is the ability to exchange protocol software ‘on the fly’ and to reconfigure complete protocol stacks, which may become necessary in various circumstances.

The approach presented here implements a framework for protocol stack reconfiguration. Protocol stacks are split into a number of functional entities described in terms of generic “classes” organised in class libraries, with dynamic binding at runtime to implement reconfigurable protocol stacks. The framework is also capable of supporting composible protocols. A single protocol layer may be replaced by a collection of components each of which implements a particular function. Inside a soft-radio terminal for instance, a “Reconfiguration Management” unit would control component selection, deletion/upgrade and communication with the PPIs. With the OPtIMA specification, there is also provided guidelines to build/implement standardised and proprietary protocol stacks using the defined APIs and PPIs.

II.1 Application Programming Interfaces and Object Orientated Design Principles

Interfaces, in general, are representations of point of access to hidden functionality in some underlying layer. The purpose of such interfaces is to encapsulate the complexity of any functional implementation and to offer the simplest possible form of access to this functionality to the user/programmer/application.

Application Programming Interfaces (APIs), in general, rely on the paradigm that interfaces hide the complexity of how functionality is actually realised. This enables programmers to simply apply the guidelines of how an interface has to be used and which parameters are to be passed for each single function call. Applications become sequences of calls to functions pre-defined within these API implementations. Much of the complexity within such applications is therefore moved down, below these programming interfaces. One of the advantages of APIs is their extensibility and partial or even complete exchangeability without necessarily requiring the complete re-writing of the application code. Other benefits of programming interfaces include the scalability and the simple use of such structures.

The basic idea of Object Orientation is to put a system's behaviour and its properties into discrete entities as described, for example, in “Object Oriented Analysis, by Coad et al, 2nd Edition, Englewood Cliffs, N.J.: Yourden Press, 1991 and this requires that functionally different parts of a system have to be identified. Once inter-relationships between entities and state or behaviour (functionality) of these entities are analysed, a formalisation and description as classes has to be done. Object Orientation relies on a number of basic principles of which the class is the major one; further concepts include Objects, Abstraction, Attributes, Operations/Methods/Services, Messages, Encapsulation, Inheritance, Polymorphism and Reuse as described in “Object Oriented Analysis and Design with Applications, by G Booch, 2nd Edition, Benjamin/Cummings Publishing, Redwood City, Calif., 1991. Examples in which OOD and APIs are used together are manifold. For example, most parts of the JFC (Java Foundation Classes) are implemented in classes, which are derived (via one to several levels of hierarchy) from the base class ‘object’. The same applies for the MFC (Microsoft Foundation Classes), which contain the base implementation classes for application programming for the Windows platform.

II.2 System Architecture

One objective of the OPtIMA model is to introduce a framework, which enables the exchange of protocols during run-time as well as the active involvement of the interfaces that enable direct signalling communication between interfaces of different protocol stack layers without accessing the layer implementation. This requires a somewhat different system view; in this approach protocols become split into ‘pro-interfaces’ and ‘pro-layers’, as shown in FIG. 1.

Pro-interfaces are active implementations defined within classes, which are derived from a base class. Here entity definitions are according to their position in the stack (pro-interface→between two pro-layers). This base class defines the generic functionality of all possible pro-interfaces. Further specialisation can then be achieved within the derived pro-interface classes. When implemented as objects, interfaces (i.e. pro-interfaces) deliver both additional functionality and additional architectural complexity.

Pro-layers are the actual protocol implementations, which obtain data through pro-interfaces, manipulate these data and export them through the pro-interfaces. Execution of functions/methods within pro-interface and pro-layer classes is controlled by thread-objects. Such a construction delivers a highly flexible platform to replace the classical protocol stacks and to enable flexible stack re-configuration during run-time. In other words, thread objects are implementing classes, which control message transport and manipulation throughout all pro-layers and pro-interfaces.

Upon arrival, a thread takes over responsibility for the messages and their processing within the complete protocol stack and then passes the references of these messages to their destinations, as illustrated in FIG. 2.

II.3 Class Architecture

A ‘functional decomposition’ of protocol stacks representing the composition of the basic entities for a open protocol implementation is illustrated in FIG. 3.

Four different class types have been identified which are:

1. Layer classes (L-classes defining pro-layers) represent the functionality of single protocols within the protocol stack (i.e. physical(P-L)-, link(LCL)-, network (NCL)- and signalling application(BSA)-functionality). Layer classes (pro-layers) inherit functionality from a generic (pro-) layer class (GLC), as shown in FIG. 4.

2. Programming Interface classes (PI-classes defining pro-interfaces) represent the various programming interfaces between the protocols (L-classes). PI-classes consist of methods that further specify and implement the generic primitives defined in a base class (GPI). The class structure and the primitive description are shown in FIGS. 5 and 7 respectively. PI-classes detect events (i.e. messages from some protocol) and trigger the execution of the appropriate thread.

3. Thread classes (T-classes) implement pre-defined procedures (e.g. Connection-, Mobility-, Radio Resource- or QoS-Management—signalling). Other, non-defined and non-standardised, signalling procedures may be implemented within customised thread classes e.g. (SST), as illustrated in FIG. 6. In addition to the implementation of message sequences, threads also enhance the flexibility of the complete protocol stack. The use of threads to execute signalling procedures enables programmers to implement several signalling procedures in parallel. This feature may be advantageous in regard to point to multipoint communications. Thread classes incorporate and use the methods defined in PI- and L-classes.

4. Protocol Stack class (PS-class) defines and represents the implementation of a complete protocol stack. Different legacy stacks (e.g. the GSM stack) may use their specified constructors to include the appropriate classes to implement the standard whilst other stacks may be freely defined. The PS-class is the only class publicly accessible within the protocol class library. Instances of this class implement any chosen protocol stack functionality. Furthermore, the PS-class manages protocol re-configurability when L-, PI- or T-classes are exchanged during run-time, as illustrated in FIG. 8. As shown, the thread classes (SST) use methods defined in both the PI and L classes.

In summary, L, PI and T classes define the capabilities, methods and properties of a protocol stack, whereas the PS-class implements those classes and so defines also the protocol stack structure.

II.4 Design Guidelines

OPtIMA relies on the aforementioned classes and a set of design rules, which define how classes and the complete protocol stack ought to be implemented. Basis for the protocol stack implementation is a code-skeleton, shown in FIGS. 12a and 12b, in which the different interface and layer classes become implemented.

The ‘Protocol Stack’ class, within one protocol stack, is the only class exporting public interfaces; it implements L-, PI- and T-objects and defines the structure of the protocol stack. The architecture as a whole uses inheritance to define a hierarchy of both different interface and different layer classes; therefore, it uses a generic interface class and a basic protocol class to derive pro-interfaces and pro-layers, respectively.

II.5 Protocol Stack and Thread Classes

The three groups of classes (PI, L, T) are instantiated, implemented and controlled by an instance of the Protocol Stack Class; this PS-object defines therefore the complete protocol stack. Classes within one of the functional groups (threads, interfaces and layers) are located within class libraries, each of which provides the functionality for their particular group of specialised (derived) classes. FIG. 3 shows the dependencies and the ‘logical location’ of classes within the protocol stack and their class libraries. Thread classes are those entities that actually manage the message passing throughout the protocol stack; they are used to handle single message sequences (i.e. each thread controls one sequence).

III. Composition of Protocol Layers and Interfaces

Separation of the protocol stack functionality into pro-layers and pro-interfaces forms a new paradigm for protocol stack development where dissemination of functionality is facilitated through open protocol programming interfaces. In the illustrated implementation, the OPtIMA architecture consists of five layers each having its own tasks and functionality. All entities within the ‘decomposed’ protocol stack (including pro-layers, pro-interfaces and Threads) are implemented as separate classes. Pro-layer classes (L-classes) contain the attributes of their protocols (layers) and are used to store information obtained from (and related to) corresponding pro-layers. L-class methods are used to process incoming information and to produce an adequate response or initiate follow up sequences. In this particular embodiment, the Layer classes and their main functions are:

Physical Layer, (modem, channel access, FEC, ciphering, etc.)

Link Layer Control, (link control)

Network Control Layer, (controls message routing)

Signalling Application Layer, (Connection Management, Resource and Mobility Management signalling)

Application Layer, applications need to be compliant to the API specification

III.1 Active Programming Interfaces

Pro-layers are separated and isolated by pro-Interfaces (PI), which ensure exchangeability and extensibility of protocol implementations during runtime. Protocol in this context refers to a legacy protocol, in contrast to the pro-layer which is the implementation of legacy (and possible proprietary) protocol functionality within OPtIMA. Appropriate PIs are defined (see class architecture (FIG. 5)) and introduced between the protocol implementations (pro-layers). Pro-interfaces provide the open protocol-programming platform; they enable interchange of signalling messages and deliver access to pro-layer classes. In this embodiment, four pro-interface classes are defined to implement a complete protocol stack (as shown in FIG. 5):

PPI12 (between Physical Layer and Link Layer Control)

PPI23 (between Link Layer Control and Network Control Layer)

PPI34 (between Network Control Layer and Signalling Application Layer)

API (Application Programming Interface)

Pro-interfaces are derived from a generic interface class (GPI) which defines four basic types of control messages known as primitives, whose task is to inform respective pro-layers about events, pass new values for variables between the pro-layers and trigger methods implemented in these pro-layer classes. Referring to FIG. 7, these four ‘primitive’ types are:

Service Request Messages (SRM): Asynchronous primitive to perform immediate, typically non-persistent actions. The flow direction for a SRM is from a high layer to a lower one.

Request Responses (RR): Persistent state or long-term measurement primitive. The flow direction for a RR is from a lower layer to a higher one.

Layer State Information (LSI): Persistent state primitive. The flow direction for a LSI is from a higher layer to a lower layer.

Asynchronous Event Notification (AEN): Asynchronous primitive to report recent, typically non-persistent events. The flow direction for an AEN is always from a lower layer to a higher one.

Exploiting object oriented programming technology, each of the pro-interface classes inherits a generic functionality from a super class called GPI. This ‘parent’ class is not part of the implemented protocol stack as a separate entity; but it exclusively defines the minimum access interface (i.e. the primitives) for all the (derived) PIs, as shown in FIG. 9. The object-oriented structure of active interface objects in conjunction with the overall architectural framework allows implementation of an additional feature: (active) pro-interfaces offer an alternative medium to pass messages and facilitate therein a common signalling and data API for application development.

As shown in FIG. 10, active interfaces are to be used to provide access to attributes within the pro-layers in two ways; sequentially (series A) and non-sequentially (series B). In series B, the attributes from pro-layer NCL are supplied to the Application layer via the PPI and API pro-interfaces, jumping the BSA pro-layer where those attributes are not needed.

The advantages of this architecture become apparent when OPtIMA is used in different communication networks; the signalling interface for applications then remains unchanged independent of the implemented protocol stack and the means of transport in the system. Adaptation to the target signalling system only takes place in the appropriate protocol (pro-layer) and that can flexibly be exchanged during run-time.

III.2 Overall Implementation of the Architecture

L- and PI-classes form the two major families/groups of classes that implement a protocol stack based on open programmable protocol interfaces. However, the functionality necessary to control signalling sequences, to deal with periodic tasks (e.g. channel measurements in the lowest layer) and to respond to external triggers has to be provided as well.

To fulfil these tasks, the family of Thread classes (T-Classes) has been introduced; in this implementation, they use the multithreading features of Java to implement concurrent message processing. Java was chosen as the implementation platform because of features such as dynamic binding and platform independence. T-classes do not, however, define any other functionality, rather they access methods defined in L (and also PI)-classes and call appropriate functions in those classes. Priority of threads (and therefore execution priority of the message sequence) can be defined during thread instantiation.

Protocol Stack classes (PS-Class) represent the whole of a protocol stack; attributes of this class are instances of all other (previously explained) classes. Thus, a PS-class exploits the functionality and the information of L-classes, uses the primitives defined in PI-classes and controls the execution of the tasks of the instantiated T-objects. This denotes that instances of the PS-class deliver the desired protocol stack functionality by implementing all required objects. Appropriate PS-class constructors can be used to implement any standard protocol stack (provided the layer classes for these standards are available). Using this structure, a protocol stack can be dynamically adapted to any particular set of requirements by exchanging the appropriate (pro-layer and thread) classes.

The following class relationships represent the complexity of the architecture (see also FIG. 11):

L-Classes depend on the PI-Class definitions: objects can access primitives of a PI-class to communicate with higher or lower layers, whilst the PI-class provides access to the information stored in a L-object or trigger any method implemented within this (L-) object.

L- and PI-classes depend on T-classes: T-objects can use the appropriate attributes and methods of L- and PI-objects to carry out its pre-defined task.

PS-class has L, PI and T-objects as attributes: PS-objects can use the functionality and the information defined in these objects directly.

T-classes depend on the PS class: PS-objects control starts and stops of various threads in its main method, but T-objects are solely responsible for the task execution. This is illustrated in FIG. 11.

All classes are structured in a class library, which provide the required signalling functionality to any network entity. The reason why classes are grouped in packages is to provide a base level of security. Declaring only the PS-class public ensures that the other objects become (theoretically) invisible and inaccessible to any other non-related object. The ‘public’ object is allowed to access the ‘private’ or ‘protected’ methods within the scope of its own attributes.

Although T-objects are directly used in the main method of a PS-object, L, PI and T-objects are used as attributes within the PS-class, and these attributes are the instances which define the appropriate objects as members of one protocol stack e.g. the reference of the PS-object is mostly used as a parameter in the methods of an L-class. In this way, if a method of an L-object is called, the object can identify the PI-objects belonging to the same PS-object and use their attributes and methods (i.e. messages).

This is shown in FIG. 9. Two operational modes for Protocol Stack objects trigger signalling/message sequences. These are either: internal (i.e. the PS-object initiates or terminates thread execution without external triggers but caused by a time-out) or external (i.e. events occurring at the application or physical layer). Both of these operational modes lead eventually to the instantiation or termination of the appropriate thread.

The flexibility of this architectural approach is based on the introduction of the generic PIs and is further consolidated by the possibility of using several concurrent threads. Generic PIs deliver the means necessary to access L-objects and to support T-objects, they provide the flexible structure necessary to support and implement different protocol stack standards. The generic set of primitives between the functional entities of the PS remains unaltered (even if new pro-layer implementations are introduced, as long as the messages comply to the four primitive types); this denotes that the PI-classes can access any pro-layer class, without being subject to changes.

IV Implementation Model

There now follows a description of a specific implementation of the OPtIMA model.

To assess proper functionality of programming interfaces, a set of QoS related messages, methods and classes has been defined and organised in a class library. The motivation for choosing QoS signalling as a test case has been the increasing complexity of interactions and variety of QoS demands expected in future generations of mobile networks, when users will be able to request mixed services (i.e. voice/video/data and other Internet services). Aurrecoechea et al (“A survey of QoS Architectures”, ACM/Springer Verlag Multimedia Systems Journal, Special Issue on QoSX Architecture, Vol 6, No. 3, pp138-151, May 1998) compare a number of different QoS architectures and discuss their particular features. It is stated that most QoS architectures merely consider single architectural levels rather than the end-to-end QoS support for multimedia communications. Furthermore, it is pointed out that QoS management features should be employed within every layer of the protocol stack and QoS control and management mechanisms should be in place on every architectural layer.

Here, a model has been implemented that incorporates support for end-to-end and level controlled QoS negotiation as examples to show both functionality and to test proper operation of communication signalling within the OPtIMA architectural framework. There now follows the definition of a generic QoS signalling message specification, a description of the protocol stack and the QoS negotiation implementation. Model 1 implementation is based on a RMI platform (running on Sun Solaris workstations) where a number of applets are implemented and used as representations of signalling (application) end points.

A set of messages and parameters are specified and defined for a generic QoS signalling structure built on the OPtIMA protocol framework. Messages and their types (i.e. primitives) for the API—pro-interface are illustrated in FIG. 12b. Naming of methods/function calls follows a general rule. The message format and message name specification is defined as:

[Name of Programming Interface][Type of Primitive][Description](arguments/parameters) { }

The following message is given as an example,

APISRMSerReq(String typeOf Service) { }

This message is part of the API (Interface between Signalling Application Layer and Application Layer. It is derived from the primitive type ‘Service Request Message’ (SRM) and contains a string as argument (i.e. typeOf Service). All messages (i.e. SRM, LSI, RR and AEN) are unidirectional in downward or upward directions, whilst SRM and LSI are downwards (from upper layer to lower layer), RR and AEN are active in the upwards direction (i.e. lower to higher layers).

The flow direction from higher to lower level or from lower to higher level is also indicated in the numbering system used:

| | | |
|---|---|---|
| PPI23RRTypeOfVariable (arguments) { } | → | Message from |
| | | Layer 2 to Layer 3 |
| PPI32LSITypeOfVariable (arguments) { } | → | Message from |
| | | Layer 3 to Layer 2 |
| APIPPILSITypeOfVariable (argument) { } | → | Message from |
| | | Application |
| | | Layer to Layer 4 |
| PPIAPIAENTypeOfVariable (arguments) { } | → | Message from |
| | | Layer 4 to |
| | | Application Layer |

Some of the messages may use the active feature of the OPtIMA and may have to access other than subsequent layers (e.g. application sending a message directly to the link layer), this as well is defined in the command naming: API2SRMTypeOfSRM(arguments) { }.

The remainder of this part contains as an example the complete list of SRMs, LSIs, RRs and AENs defined for the QoS signalling API. Model 1 has enabled verification and validation of both the architecture and the specification of programming interfaces. To prove the validity of OPtIMA and proper functioning of the pro-interface implementations, the QoS messaging part of the API has been taken as an example.

| | | |
|---|---|---|
| SRM | Parameters | Description |

Service Request Message (SRM)

| APISRMSerReq | p.index | Service Request |
|---|---|---|
| APISRMSerChange | p.index | Service Modification Request |
| APISRMDisconnect | p | Disconnection |
| APISRMSerContd | p | Service Continues |
| LSI | Parameters | Description |

Layer State Information (LSI)

| | | |
|---|---|---|
| APIPPILSIQoSProvided | pqosAccept | Qos Provided Accept/Deny |
| AEN | Parameters | Description |

Asynchronous Event Notification (AEN)

| | | |
|---|---|---|
| APIAENSerReqOK | p | Service Request OK |
| APIAENSerReqFail | p | Service Request Fail |
| APIAENQoSProvided | p | Provided QoS for Service |
| | | Request |
| APIAENSerChangeOK | p | Service Modification Request |
| | | OK |
| APIAENSerChangeFail | p | Service Modification Request |
| | | Fail |

Request Reply (RR) not applicable

FIGS. 12a and 12b, depict the skeleton code for QoS negotiation and the set of messages for the API pro-interface respectively. There now follows descriptions of the implemented model and class structure for QoS negotiation and management at the API.

IV.1 Model Description

In Model 1 the implementation consists of a server applet and a number of client applets, with both applet classes displaying the QoS negotiation. QoS classes defined in OPtIMA facilitate messaging between client and server using Java RMI as transport media.

The applets are used as signalling end-points to negotiate and display the QoS settings. Communication between those end-points takes place via the API using an underlying layer class (pro-layer), which implements the RMI connection via interfaces (Stub and Skeleton) to the Java Object Broker (RMI). Client-Stub and Server-Skeleton implementations in this model, are representative of the pro-layer classes. The protocol stack (used in this test platform) consists of an application layer (L-class), an API (PI-class) and a general layer class (L-class) representing the remainder of the protocol stack. The functionality of this model relies on the basic client/server principle, where objects are distributed across the network and communicate via a middleware layer (object broker). Clients request services, via the request broker, from remote server objects. The (RMI) broker uses interfaces bound to the implementations of clients and servers called stubs and skeletons, respectively. Stubs and skeletons hide the complexity of the communication between client and server, they control sterilisation and de-marshalling of parameters and they establish, maintain and terminate connections between the remote entities. Application layer classes are implemented as applets (Client Applet and Server Applet), they provide the graphical user interface (GUI) of the signalling end-points. Java AWT (abstract windowing toolkit) is used to implement the GUI and Solaris on Sun workstations as computing platforms.

The general layer class (RMI Class Client and Class Server) represents the test-platform-version of the protocol stack. This class is derived from the signalling application layer class, all QoS information available in lower layers being accessible via this class. Moreover, the general layer class accesses the Java's RMI Stub and Skeleton class. RMI-Client and -Server classes are implemented as separate classes and they provide the means for (RMI) distributed object computing endpoints, as shown in FIG. 13. Client and Server applets are shown in FIGS. 14 and 15, respectively. Their data fields represent requested and provided QoS parameters.

The Applet ‘Client’ consists of a number of components that include:

A text area, which is used to inform the user about general events.

Nine text fields, which display the parameters of an established connection.

A multiple choice, which enables the user to request a specific service.

A text field, where the user inserts the destination Id.

A number of buttons, which are used to enable the user to interact with the terminal.

The Applet ‘Server’ consists of the following set of components:

A text area, which is used to inform the administrator about general events.

A column of nine text fields, which display either the parameters of an established connection or the parameters of a request (depending on the type of the last request).

A column of multiple choices, which manually determine the current conditions of the network. The manual determination of the network conditions was necessary, since there is not an actual flow of user data. The test platform implements the signalling plane of the protocol stack. Thus measurements of the flow parameters such as delay and BER are not feasible.

A choice, which is used to enable the administrator to deny all the requests independently of the current network conditions.

The parameters, which are used to describe the quality of service and the quality provided by a connection (or a service request), are as follows:

Standard: Determines the type of standard e.g. GSM, DECT, etc.

IdField: Determines the identity of the client (e.g. TMSI/IMSI for GSM).

LocationId: Specifies the location of the mobile client (e.g. LAI for GSM).

Bandwidth: Determines the bandwidth of a connection or a request in kbps. This bandwidth can specify average, maximum, best effort, predicted or guaranteed bandwidth, depending on the type of standard.

Delay: Specifies the delay of a connection or a request. It could be referred to average, maximum, best effort, predicted or guaranteed delay, depending on the type of standard.

Priority: Specifies the relative importance of a connection with respect to the order in which connections are to have their QoS degrated (if necessary) and the order in which connections are to be released to recover resources (if necessary).

Protection: Determines the extent to which a Service Provider attempts to prevent unauthorised monitoring or manipulation of user-originated information.

The experimental set-up consisted of the server applet running on a SUN Solaris server and a number of client applets running on distributed x-terminals, which were connected to the server machine via an ATM hub (over 10/100 Mbits/s Ethernet connections). As an example of operation of Model 1 implementation, we briefly describe the operation of the simplified signalling messages sequence for QoS re-negotiation presented in FIG. 16. The client requests a modification of the already provided service from the server (Service Modification). It passes to the server all the required QoS parameters and information related to the identity of the client. The server processes this request and examines the required QoS, the availability of local resources i.e. current loading due to all clients, and the resources already assigned to this client. Then it informs the client whether the new request is accepted or not (Service Modification Response). The client acknowledges the previous message (Service Modification Response ack.). In case the request is not accepted, the client can either disconnect or continue the current session with the previous QoS values.

The described embodiments have the following significant attributes:

A protocol re-configuration platform (i.e. an architectural framework containing a detailed specification of a library of generic interface classes (APIs/PPIs) is provided and used to implement reconfigurable protocol stacks in a flexible and open manner using object oriented programming techniques.

Implementation guidelines/specifications to build standard and non-standard protocol stacks using the APIs and PPIs (provided in the defined libraries). Using an open programming platform requires the specification of how applications and protocol layers are to be programmed.

The API/PPIs can work with legacy implementation of protocol layers as well as component-based forms of protocol layer i.e. the framework supports composible protocols.

Protocol reconfiguration requires the control/supervision of a “Reconfiguration Manager” unit.

Two different implementation models for the proposed open programmable protocol interfaces have been proposed and assessed. Both offer the required flexibility to support protocol stack re-configuration. The first possible solution proposes an architecture in which even the interfaces are implemented as objects, whereas the second proposal follows the classical definition of APIs, in which the API is merely a formal definition implemented in the underlaying layer. Although both implementation strategies can be supported within OPtIMA, the current OPtIMA architecture has been based on the former of the two implementation models.

By extending the existing base protocol classes and customisation, it is possible to implement application-specific behaviour i.e. users are permitted to install and run their own custom protocol stacks, protocol layer or addition/deletion of components within any given layer, thus tailoring protocol functionality/components to application requirements. It is assumed that Protocol classes are implemented compliant to the appropriate API/PPI, by the vendors.

The proposed PIs are capable of mapping the application QoS onto network and link-layer QoS parameters, as required within wireless mobile networks.

The OPtIMA architecture is implemented in Java. Java platform was selected as it supports code mobility, OO properties, serialisation, inheritance and encapsulation properties.

1. A protocol stack for a communications system wherein the stack has an architecture incorporating active programming interfaces capable of supporting reconfiguration of the stack.

2. A protocol stack as claimed in claim 1 comprising
a plurality of protocol layers and a plurality of said active programming interfaces interleaved with said protocol layers, wherein functionality of said protocol layers is defined by protocol layer classes and functionality of said active programming interfaces is defined by programming interface classes.

3. A protocol stack as claimed in claim 2 wherein execution of the respective functions of said protocol layer classes and said programming interface classes is controlled by thread objects defined by thread classes.

4. A protocol stack as claimed in claim 3 wherein said classes are stored in one or more class library.

5. A protocol stack as claimed in claim 2 wherein said protocol layer classes have functionalities derived from a generic layer class and said programming interface classes have functionalities derived from a generic interface class.

6. A protocol stack as claimed in claim 3 wherein said protocol layer classes, said programming interface classes and said thread classes are implemented and controlled by a protocol stack class.

7. A protocol stack as claimed in claim 6 wherein said protocol stack class facilitates exchange of said protocol layer, programming interface and thread classes during protocol reconfiguration.

8. A protocol stack as claimed in claim 7 wherein said protocol stack class defines the structure of the stack.

9. A protocol stack as claimed in any one of claims 1 to 8 wherein said protocol layers consist of a physical layer, a link control layer, a network control layer, a signalling application layer and an application layer.

10. A protocol stack as claimed in any one of claims 2 to 9 wherein said active programming interfaces are configured to enable direct signalling communication between different active programming interfaces without accessing implementation of said protocol layers.

11. A protocol stack as claimed in claim 5 wherein said generic interface class defines a plurality of basic control messages (primitives).

12. A protocol stack as claimed in claim 11 wherein there are four said primitives consisting of Service Request Messages, Request Responses, Layer State Information and Asynchronous Event Notification.

13. A protocol stack as claimed in any one of claims 2 to 4 wherein at least one of said classes depends on at least one other class.

14. A protocol stack as claimed in claim 4 wherein said one or more class library is a secure library.

15. A protocol stack as claimed in any one of claims 6 to 8 wherein said protocol stack class is publicly available.

16. A protocol stack as claimed in claim 1 wherein said active programming interfaces enable access to attributes within protocol layers of the stack either sequentially or non-sequentially.

17. A reconfigurable protocol stack for a communications system comprising,
a plurality of protocol layers and a plurality of active programming interfaces interleaved with said protocol layers, wherein each said protocol layer has functionality defined by a layer object selectable from a respective one of a plurality of different layer classes, each said active programming interface has functionality defined by an interface object selectable from a respective one of a plurality of different interface classes, and thread objects are selectable from a plurality of thread classes for controlling message sequences within the protocol stack.

18. A protocol stack as claimed in claim 17 wherein each said interface class inherits functionality from a generic interface class that is common to all said interface classes.

19. A protocol stack as claimed in claim 18 wherein each said interface class defines additional functionality specific to the respective interface class.

20. A protocol stack as claimed in claim 18 or claim 19 wherein said generic interface class defines a plurality of basic control message types.

21. A protocol stack as claimed in claim 20 wherein said basic control message types include Service Request Messages, Request Responses, Layer State Information and Asynchronous Event Notification.

22. A protocol stack as claimed in any one of claims 17 to 21 including a protocol stack class arranged to implement said layer classes, said interface classes and said thread classes.

23. A protocol stack as claimed in claim 22 wherein said protocol stack class is further arranged to exchange, during run-time, one said layer object for another said layer object from the same layer class and/or exchange one said interface object for another said interface object from the same interface class whereby to change functionality of a corresponding said protocol layer and/or a corresponding said active programming interface during protocol stack reconfiguration.

24. A protocol stack as claimed in any one of claims 17 to 23 wherein said layer classes, said interface classes and said thread classes are stored in, and selectable from a class library.

25. A protocol stack as claimed in claim 22 or claim 23 wherein said layer classes, said interface classes and said thread classes are stored in, and selectable from a class library, and implementation of said protocol stack class provides a public interface.

26. A protocol stack as claimed in any one of claims 17 to 25 wherein said active programming interfaces are so configured as to permit messages to pass directly between any two said active programming interfaces by-passing any intervening protocol layer.

27. A protocol stack as claimed in any one of claims 1 to 26 wherein each said layer class inherits functionality from a generic layer class common to all said layer classes and has additional functionality specific to the respective layer class.

28. A protocol stack as claimed in any one of claims 18 to 21 wherein a said layer class inherits functionality from said generic interface class.

29. A protocol stack as claimed in any one of claims 17 to 28 wherein said thread classes derive functionality from said layer and interface classes.

30. A communications system comprising a network and at least one terminal respectively incorporating a protocol stack as claimed in any one of claims 1 to 29, each said protocol stack being independently reconfigurable.

31. A communications system as claimed in claim 30 wherein said at least one terminal is a software-reconfigurable radio.

32. A method for reconfiguring a protocol stack for a communications system, the protocol stack comprising a plurality of protocol layers and a plurality of active programming interfaces interleaved with the protocol layers, each said protocol layer having functionality defined by a layer object selectable from a respective one of a plurality of different layer classes and each said active programming interface having functionality defined by an interface object selectable from a respective one of a plurality of different interface classes, the method including the step of exchanging one said layer object for another said layer object from the same layer class and/or exchanging one said interface object for another said interface object from the same interface class whereby to change functionality of the corresponding protocol layer and/or the corresponding active programming interface.

33. A protocol stack substantially as hereindescribed with reference to the accompanying drawings.

34. A communications system substantially as hereindescribed with reference to the accompanying drawings.
